(19) United States
(12) Patent Application Publication
(10) Pub. No.: US 2003/0211784 A1
(43) Pub. Date: Nov. 13, 2003

(54) External USB adapter

(76) Inventors: Sheng-Tu Wu, San Chung City (TW); Yi-Hsin Huang, Taipei (TW)

Correspondence Address: HOFFMAN, WASSON & GITLER, P.C., Suite 522, 2361 Jefferson Davis Highway, Arlington, VA, 22202, US

(21) Appl. No.: 10/265,391

(22) Filed: Oct. 7, 2002

(30) Foreign Application Priority Data
May 10, 2002 (TW) 91206694

(51) Int. Cl. H01R 25/00

(52) U.S. Cl. 439/638

(57) ABSTRACT

The present application relates to an external USB (UNIVERSAL SERIAL BUS) adapter. The external USB adapter is an interface-converting apparatus, thereby externally installing a storage medium device or other peripheral components on a personal computer via a USB port of the personal computer. The external USB adapter comprises: an upper cover; a lower cover; a printed circuit board located between the upper cover and the lower cover; a USB-end socket connected to the printed circuit board; an external-device-end socket connected to the printed circuit board; and at least one external fixing element. The printed circuit board further comprises a drive IC.

### FIELD OF THE INVENTION

The present invention relates to an external USB (Universal Serial Bus) adapter, and more particularly, to an interface adapter connecting a storage medium device with a non-USB interface to a personal computer via a USB port of the personal computer.

### BACKGROUND OF THE INVENTION

With the rapidly and continuously new development of various applications of personal computer, the peripheral components of personal computer has to be frequently expanded, especially the storage medium device. For example, a single-slot notebook computer only having one CD-ROM drive is expanded to dual slots, of which one slot is for CD-ROM drive and the other slot is CD writer, used for performing a copying step between these two slots or performing data backup. The storage medium device can be, for example, a hard disk drive, a CD-ROM drive, a CD writer, a DVD drive or a CF (Compact Flash) card reader/writer, etc. However, due to the limitation of space and original hardware specification, particularly for the notebook computers mostly merely having a single slot of CD-ROM drive, it is not easy to expand the notebook computer to a dual-slot one.

Currently, as long as the personal computers are newly purchased, they all support the so-called USB interface. The technology of USB interface can be used for connecting newly-added peripheral components to a computer, and the newly-added peripheral components can be configured to the computer automatically. Moreover, the USB interface can support a lot of devices by the way of serial connection, i.e. a first device is connected to a computer, and then a second device is connected to the first device, and then a third device is connected to the second device, and so on. Hence, a USB port on a personal computer can be used to install the other storage medium device, thereby attaining the purpose of expand a single-slot personal computer to a dual-slot one.

However, there are quite many storage medium devices that still use non-USB interfaces, such as IDE, PCI or PCMCIA, etc. Hence, there is a need to develop an external USB adapter for conveniently installing a storage medium device with non-USB interface to a personal computer.

### SUMMARY OF THE INVENTION

In view of the aforementioned background, it is not easy to expand a single-slot personal computer (such as a notebook computer) to a dual-slot one. Therefore, a USB port of the personal computer can be used for connecting another medium storage device, such as a hard disk drive, a CD-ROM drive, a CD writer, a DVD drive or a CF card reader/writer, etc., so as to attain the purpose of expanding a single-slot notebook computer to a dual-slot or multi-slot one. However, most of the storage medium devices still employ non-USB interfaces, such as IDE, PCI or PCMCIA, etc.

Hence, it is an object of the present invention to provide an external USB adapter, whereby a storage medium device with a non-USB interface can be installed on a personal computer, so as to attain the purpose of expanding the storage medium device of the personal computer. Further, the object of the present invention is to allow another peripheral component with a non-USB interface to be installed on a personal computer briefly, so as to attain the purpose of expanding the peripheral components of the personal computer.

According to the aforementioned object, the present invention provides an external USB adapter. The external USB adapter of the present invention comprises: an upper cover; a lower cover; a printed circuit board located between the lower cover and the upper cover; at least one external connecting element located between the lower cover and the upper cover for fixing a storage medium device or other peripheral component externally attached; a USB-end socket that is electrically connected to the printed circuit board and located between the upper cover and the lower cover, thereby connecting to a USB port of a personal computer via a USB cable; an external-device-end socket that is electrically connected to the printed circuit board and located between the upper cover and the lower cover, thereby connecting to the storage medium or other peripheral component via a connector or a signal transmission cable; and internal fixing elements used for connecting and fixing the upper cover, the lower cover and the printed circuit board together. The printed circuit board further comprises a drive IC (Integrated Circuit) used for perform an interface conversion to convert a non-USB interface to a USB interface.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic explosive view of an external USB adapter of a preferred embodiment of the present invention;

FIG. 2 is a schematic diagram showing the outlook of the external USB adapter of the preferred embodiment of the present invention; and

FIG. 3 is a schematic diagram showing the combination of the external USB adapter and an externally-attached module, according to the preferred embodiment of the present invention.

### DETAILED DESCRIPTION OF THE PREFERRED EMBODIMENT

The present invention discloses an external USB adapter. The external USB adapter of the present invention is used for briefly installing a storage medium device or other peripheral component with a non-USB interface on a personal computer, as long as the personal computer has installed and supported a USB port.

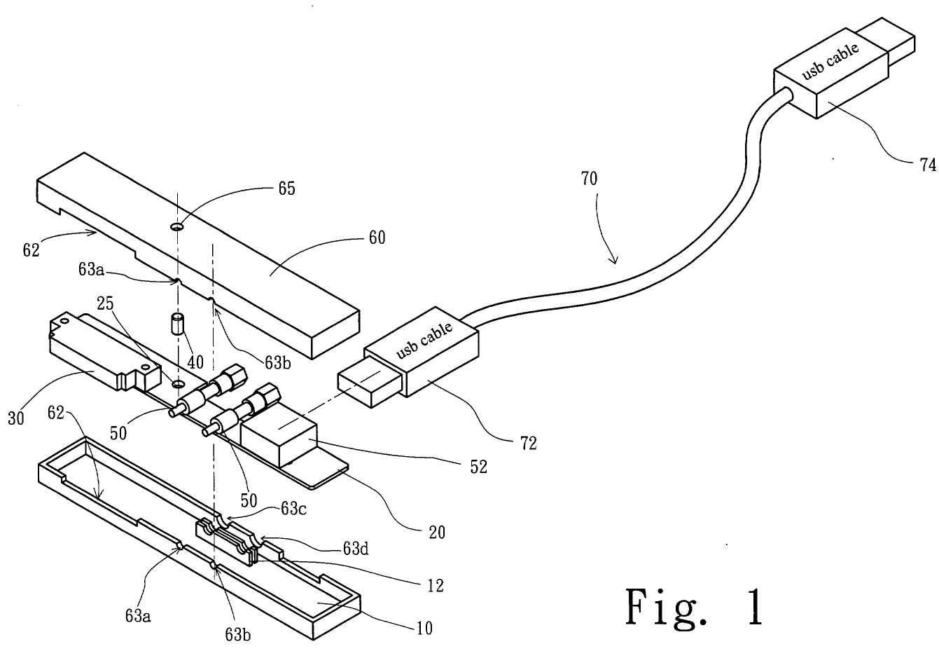

Referring to FIG. 1, FIG. 1 is a schematic explosive view of an external USB adapter of a preferred embodiment of the present invention. The external USB adapter comprises: a printed circuit board 20; a USB-end socket 52 electrically connected to the printed circuit board 20; and an external-device-end socket 30 electrically connected to the printed circuit board 20. A first plug 72 of a USB cable 70 is inserted into the USB-end socket 52, and a second plug 74 of the USB cable 70 is inserted into a USB port (not shown) of a personal computer. The external-device-end socket 30 is used for connecting to a connector or a signal transmission cable (not shown) of a storage medium device or other peripheral components. The present invention further uses at least one external connecting element 50 (such as two external connecting elements) to fix the externally-attached medium storage device or other peripheral components, wherein the external connecting elements 50 can be, for example, screws. The printed circuit board 20 further comprises a drive IC (not shown) used for performing signal conversion to convert signals from a non-USB interface (such as IDE interface) to a USB interface.

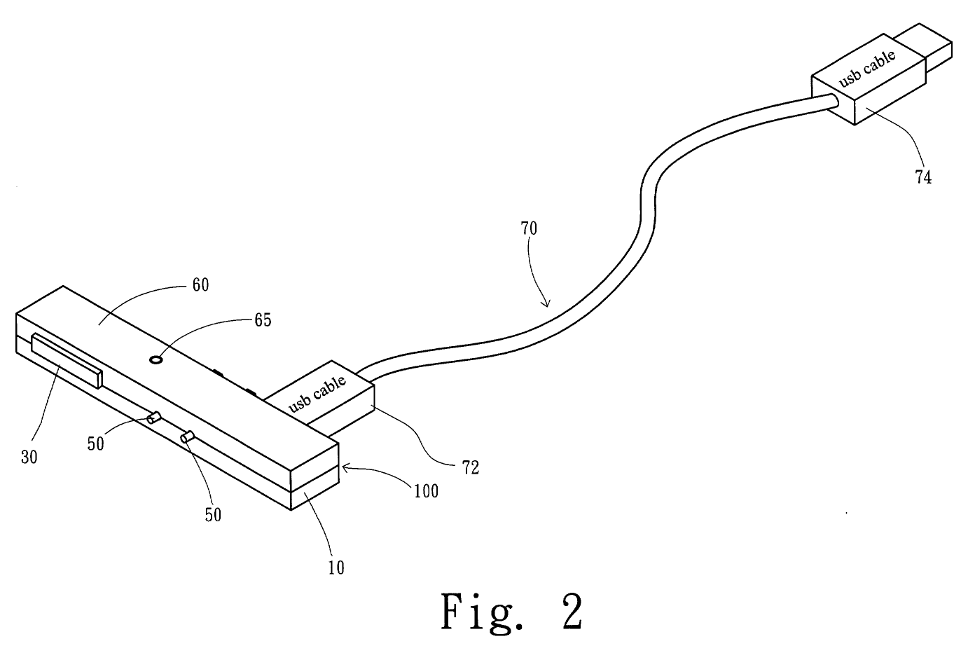

Please continuously refer to FIG. 1. The present invention further comprises: a lower cover 10; and an upper cover 60, and the lower cover 10 and the upper cover 60 are combined as a housing (such as label 100 shown in FIG. 2), wherein the printed circuit board 20, the external-device-end socket 30 and the USB-end socket 52 are all located inside the housing 100, i.e. between the lower cover 10 and the upper cover 60. The external-device-end socket 30 and the USB-end socket 52 both can be located above the printed circuit board 20, such as shown in FIG. 1, or can be located below the printed circuit board 20. The present invention can also dispose a light element 40, for example, a LED module, inside the housing (such as label 100 shown in FIG. 2). The light element 40 can be disposed on a connecting pad 25 of the printed circuit board 20, and is electrically connected thereto, by which the status of the adapter or that of an externally-attached module can be shown by the light element 40 through a hole 65 located on the upper cover 60. Moreover, there are internal fixing elements (not shown) disposed in the housing (such as label 100 shown in FIG. 2) formed by the upper cover 60 and the lower cover 10, and the internal fixing elements are used for connecting and fastening the lower cover 10, the printed circuit board 20 and the upper cover 60. The external connecting elements 50 can be disposed on at least one supporting holder 12 in the lower cover 10. The lower cover 10 and the upper cover 60 have a plurality of notches 62, 63a, 63b, 63c and 63d corresponding to each other, and those notches are used for exposing a portion of the external-device-end socket 30 and that of the external connecting elements 50.

It is worthy to be noted that the external-device-end socket 30 can be either male type or female type in accordance with the type of externally attached storage medium device or other peripheral components. The application regarding the internal connecting elements is not limited to the method of using fixing holes. According to the actual situation and design, other methods can also be used, such as the method of adhering by glue. Moreover, the personal computer applied in the present invention can be either the type of either desktop or laptop (notebook). Moreover, the shapes, numbers and locations, etc., of the related components as mentioned above are merely stated as examples for explanation, and the present invention is not limited thereto.

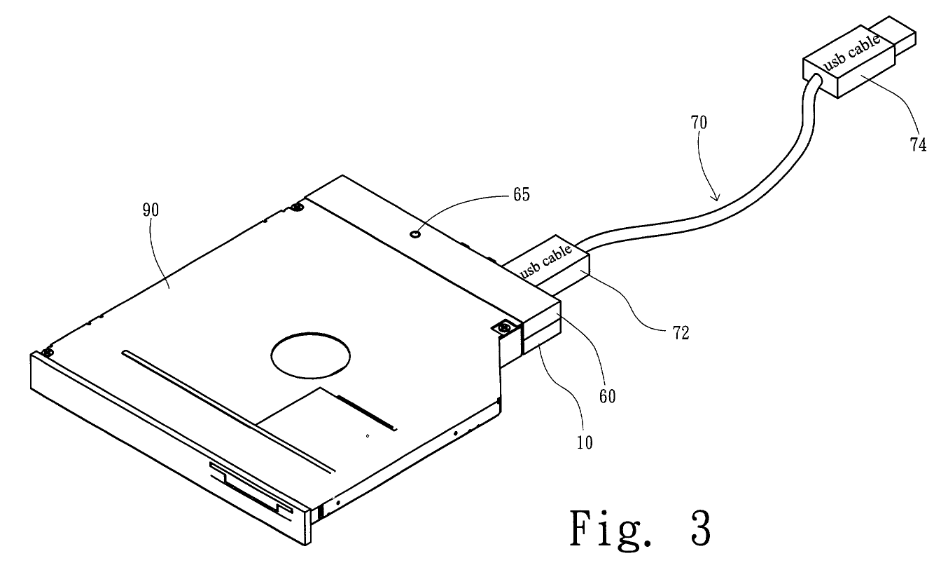

Referring to FIG. 2, FIG. 2 is a schematic diagram showing the outlook of the external USB adapter of the preferred embodiment of the present invention. After the external USB adapter of the preferred embodiment of the present invention is assembled, the upper cover 60 and the lower cover 10 are tightly combined together to form a housing 100, and exposes a portion of the external-device-end socket 30 and that of the external connecting elements 50, wherein the printed circuit board (not shown) is contained between the upper cover 60 and the lower cover 10. While applying the external USB adapter of the preferred embodiment of the present invention, a user merely has to do the following steps: using the external connecting elements 50 to fix the storage medium device or other peripheral component on one side of the combination of the upper cover 60 and the lower cover 10 (i.e. one side of the housing 100); then connecting the connector or the signal transmission cable of the storage medium device or other peripheral component to the external-device-socket 30; and thereafter using the USB cable 70 having the first plug 72 and the second plug 74 to connect the present invention to the personal computer. Referring to FIG. 3, FIG. 3 is a schematic diagram showing the combination of the external USB adapter and an externally-attached module, according to the preferred embodiment of the present invention, wherein the externally-attached module 90 can be a storage medium device or other peripheral component.

Hence, it is an advantage of the present invention to provide an external USB adapter. By applying the present invention, a storage medium device with a non-USB interface can be installed on a personal computer, thus attaining the purpose of expanding the storage medium device of the personal computer. The present invention can be used for allowing other peripheral component with a non-USB interface to be installed on a personal computer briefly, so as to attain the purpose of expanding the peripheral components of the personal computer.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An external USB (Universal Serial Bus) adapter, used for connecting an externally-attached module to a personal computer having a USB port of a USB interface, wherein said external USB adapter uses a USB cable having a first plug and a second plug to connect to said personal computer, said external USB adapter comprising:
a lower cover;
an upper cover, corresponding and connecting to said lower cover;
a printed circuit board, located between said lower cover and said upper cover, wherein said printed circuit board further comprises a drive IC (Integrated Circuit) used for converting signals between different interfaces and transmitting signals to said USB interface;
a USB-end socket, connected to said printed circuit board for inserting said first plug, and said second plug is inserted into said USB port of said personal computer;
an external-device-end socket, electrically connected to said printed circuit board for connecting said externally-attached module; and
a connecting element, disposed between said upper cover and said lower cover for connecting said externally-attached module to said external USB adapter, so as to fix said externally-attached module to one side of the assembly of said upper cover and said lower cover.

2. The external USB adapter of claim 1, wherein said connecting element is a screw.

3. The external USB adapter of claim 1, wherein said externally-attached module is a peripheral component.

4. The external USB adapter of claim 3, wherein said externally-attached module is a storage medium device.

5. The external USB adapter of claim 1, wherein said external-device-end socket is male type.

6. The external USB adapter of claim 1, wherein said external-device-end socket is female type.

7. The external USB adapter of claim 1, wherein said USB-end socket and said external-device-end socket are located between said lower cover and said upper cover, and said lower cover and said upper cover have a plurality of notches corresponding to each other, thereby exposing a portion of said connecting element and that of said external-device-end socket.

8. The external USB adapter of claim 1, wherein said connecting element is installed on a supporting holder in said lower cover.

9. An external adapter, used for connecting an externally-attached module to a personal computer having a USB port of a USB interface, said external adapter comprising:
a housing;
a printed circuit board, disposed in said housing for performing an interface conversion and transmitting signals to said USB interface;
a USB-end socket, which is disposed in said housing and electrically connected to said printed circuit board;
an external-device-end socket, which is disposed in said housing and electrically connected to said printed circuit board; and
an external connecting element, disposed in said housing for connecting said externally-attached module to said external adapter, so as to fix said externally-attached module to one side of said housing.

10. The external adapter of claim 9, wherein said external connecting element is a screw.

11. The external adapter of claim 9, wherein said externally-attached module is a peripheral component.

12. The external adapter of claim 11, wherein said peripheral component is a storage medium device.

13. The external adapter of claim 9, wherein said external-device-end socket is male type.

14. The external adapter of claim 9, wherein said external-device-end socket is female type.

15. The external adapter of claim 9, wherein said housing further comprises a lower cover; and an upper cover, wherein said printed circuit board is located between said lower cover and said upper cover.

16. The external adapter of claim 15, wherein said USB-end socket and said external-device-end socket are located between said lower cover and said upper cover, and said lower cover and said upper cover have a plurality of notches corresponding to each other, thereby exposing a portion of said connecting element and that of said external-device-end socket.

17. The external adapter of claim 9, wherein said printed circuit board further comprises a drive IC used for converting signals between different interfaces and transmitting signals to said USB-end socket.
